(19) United States
(12) Patent Application Publication
(10) Pub. No.: US 2011/0244113 A1
(43) Pub. Date: Oct. 6, 2011

(54) METHOD OF TOOTH SURFACE TREATMENT

(75) Inventor: Hien NGO, Fig Tree Pocket (AU)

(73) Assignee: GC Corporation, Itabashi-ku (JP)

(21) Appl. No.: 12/751,278

(22) Filed: Mar. 31, 2010

(51) Int. Cl. B05D 3/06

(52) U.S. Cl. 427/2.29

(57) ABSTRACT

The method of tooth surface treatment includes the steps of applying a photopolymerization type dental surface coating material to a smooth surface of an erupted tooth and/or a non-cavitated caries, and thereafter irradiating light on the applied part to polymerize and harden the photopolymerization type dental surface coating material. By applying the photopolymerization type dental surface coating material used in the present invention to the smooth surface of the erupted tooth and/or the tooth before forming a cavity, the smooth surface of the erupted tooth and/or the tooth before forming a cavity can be protected for a long period of time from a dental caries.

### BACKGROUND OF THE INVENTION

1. Field of the Invention

The present invention relates to a method of tooth surface treatment for an erupting or erupted tooth, and/or a non-cavitated caries lesion. The proposed method includes applying a long lasting coating on the smooth surface of an erupted tooth which will effectively inhibit the development and progression of dental caries on the treated surface. The coating works primarily by providing a physical barrier to protect the tooth surface, secondarily by reducing bacteria adhesion and by giving chemical protection to the tooth.

2. Description of the Conventional Art

The most common sites for caries lesions are the pits and fissures on the occlusal of an erupted tooth; however most of the these lesions started during childhood. In teenagers and young adults the proximal, buccal, lingual and palatal smooth surfaces become more susceptible to plaque accumulation and, therefore, dental caries attack.

Therefore, various remedies have been developed to protect and prevent the formation and progression of caries lesions on these surfaces. For occlusal caries, the best accepted method is fissure sealant. This method relies on the penetration of resin into the pits and fissures system.

We are proposing a method to protect the smooth surfaces of a tooth from dental caries.

However, this method is equally applicable to enamel and dentine smooth surfaces.

In the case of non-cavitated caries lesions, such as white spots and the like, although a cavity is not yet formed, enamel on a tooth surface is porous and weakened, without intervention it will progress to becoming a cavity. Thus, it is crucially important to intervene by strengthening a tooth surface and also to stop bacteria adhering and plaque accumulating directly on the surface of the white spot lesions. It is anticipated that when the proposed treatment is applied to a sound surface it will render it more resistant to acid and when this is applied to a surface with an existing white spot lesion the proposed treatment will prevent the lesion from progressing.

The proposed treatment will provide long term protection. One of the challenges we are facing is to provide long term retention, despite the lack of natural retentive features which are present on the occlusal surface, such as pits and fissures.

Conventional methods for strengthening enamel and dentine include applying a temporary coat of phosphate fluoride liquid or a diamine silver fluoride liquid or the like. The longevity of these treatments are limited to weeks or a few months.

Another approach, which has been tried, is to incorporate an antibacterial agent into dental restorative materials such as a composite resin, a dental cement, or the like, and a method of coating a composition blended with an antibacterial agent. These compositions can be applied on a tooth surface or in the oral cavity.

In the case of the proximal surfaces, gaining proper access and isolation are difficult or impossible, using existing methods refer to Patent Laid-Open Gazette No. H4-189661, Patent Laid-Open Gazette No. H4-346905, Patent Laid-Open Gazette No. H5-126398, Patent Laid-Open Gazette No. H5-015435, Patent Laid-Open Gazette No. H6-192060, Patent Laid-Open Gazette No. H7-206621, Patent Laid-Open Gazette No. H7-215814, Patent Laid-Open Gazette No. 2006-507361, Patent Laid-Open Gazette No. 2006-505303, Patent Laid-Open Gazette No. 2007-254300 and Patent Laid-Open Gazette No. 2007-269637.

However, when a dental restorative material blended with an antibacterial agent is used, it must be a precondition that a tooth has a cavitated caries at the time of using the dental restorative material. Thus, the dental restorative material cannot be applied for preventing a dental caries of the erupting or erupted tooth having non-cavitated caries or a smooth tooth surface of a tooth on which a cavity has not yet formed. Instead, an antibacterial composition has been developed. There are two problems which are common to the above methods, for coating on a tooth surface, are: Firstly, low retention in the oral cavity so the anti-bacterial benefit is also short term. Secondly, access the surfaces which require protection can be limited and difficult once the tooth is fully erupted. In conclusion, the existing methods and compositions, when applied to smooth tooth surfaces, cannot provide long term protection due to lack of retention.

### SUMMARY OF THE INVENTION

### Problem to be Solved by the Invention

The present invention is directed to a method of tooth surface treatment applicable to the smooth tooth surface or the like of an erupting or erupted tooth, and/or a tooth before the formation of a cavity.

### Means for Solving the Problem

The present inventors would like to the problems previously described in this paper. As a result, they discovered the followings to complete the present invention.

The aforementioned problems can be solved by performing a tooth surface treatment method by using a photopolymerization type dental surface coating material.

### Effect of the Invention

The method of tooth surface treatment according to the present invention is an excellent method capable of dealing applicable to cases in which using a dental restorative material is not possible, for example, a non cavitated smooth surface of the erupting or erupted tooth.

### DETAILED DESCRIPTION OF PREFERRED EMBODIMENT

According to an aspect of the present invention, the method of tooth surface treatment includes the steps of applying a specific photopolymerization type dental surface coating material to a smooth surface of the erupting or erupted tooth, and/or a non-cavitated caries lesion, and thereafter irradiating the treated area to polymerize and harden the photopolymerization type dental surface coating material. By applying the photopolymerization type dental surface coating material used in the present invention to a smooth surface of an erupting or erupted tooth, and/or an initial lesion without a cavity, the smooth surface of an erupting or erupted tooth, and/or an initial lesion without a cavity can be protected for a long period of time against dental caries.

In the present invention, as the inorganic fine particles having 1-100 nm average particle diameter and the surfaces modified with alkoxysilane having an unsaturated double bond, a commonly known compound oxide having the surfaces modified with alkoxysilane can be used without limitation. The compound oxide is, for example, silica, silica-alumina, silica-zirconia or the like. In the photopolymerization type dental surface coating material according to the present invention, the inorganic fine particles having 1-100 nm average particle diameter and the surfaces modified with alkoxysilane having an unsaturated double bond is necessary to be blended in the composite in the mono-dispersed state, and thus a material supplied in the mono-dispersed state in the making process of the (meth)acrylate monomer is used. For example, such a material is indicated in Japanese Patent Laid Open No. H7-291817.

As the alkoxysilane having an unsaturated double bond used in the present invention, a silane compound conventionally used in the dental material can be used. More particularly, at least one compound selected from the followings is preferable, that is, 3-methacryloxypropyl trimethoxysilane, 3-methacryloxypropyltriethoxysilane, 3-acryloxypropyltrimethoxysilane, 3-methacryloxy propylmethyldimethoxysilane, 3-methacryloxypropyl methyldiethoxysilane, 3-acryloxypropylmethyl dimethoxysilane, 2-methacryloxyethoxypropyl trimethoxysilane, vinyltrimethoxysilane, vinyltriethoxy silane, and vinyltris(2-methoxyethoxy)silane.

The inorganic fine particles having 1-100 nm average particle diameter and the surface modified with alkoxysilane having an unsaturated double bond, which is used in the photopolymerization type dental surface coating material, is necessary to be blended 1-70% by weight in the (meth)acrylate monomer. When the blending amount is less than 1% by weight, the strength of the surface of the photopolymerization type dental surface coating material after curing is insufficient. When the blending amount is more than 70% by weight, the viscosity of the photopolymerization type dental surface coating material is too high, and thus it is not preferable. More preferably, the blending amount is 5-30% by weight.

In the photopolymerization type dental surface coating material using in the present invention, as the (meth)acrylate monomer, which is a base material, containing the inorganic fine particles having 1-100 nm average particle diameter and the surfaces modified with alkoxysilane having an unsaturated double bond, any of the (meth)acrylate monomer conventionally used in the dental material can be used. However, when 15-70% by weight of volatile (meth)acrylate monomer is used in the (meth)acrylate monomer in the whole photopolymerization type dental surface coating material, the volatile (meth)acrylate monomer on the surface of the coated film is rapidly evaporated and then, the concentration of the photopolymerization initiator on the surface increases at the time of coating on the surface of the dental resin material. Then, the surface curability of the photopolymerization type dental surface coating material can increases. Therefore, it is preferable to use the volatile (meth)acrylate monomer.

As the volatile (meth)acrylate monomer, for example, the followings can be used, that is, methyl acrylate, methyl methacrylate, ethyl acrylate, ethyl methacrylate, 2,2,2-trifluoroethyl acrylate, and 2,2,2-trifluoroethyl methacrylate. In these monomers, methyl methacrylate is the most preferable when safety and volatility is considered. As for the blending amount of the volatile (meth)acrylate monomer used in the present invention, it is preferably 15-70% by weight in the (meth)acrylate monomer when drying characteristics of the coated surface and the strength after curing are considered. When it is less than 15% by weight, the drying characteristics and the strength of the surface may decrease. When it is more than 70% by weight, the surface curability may decrease.

In the photopolymerization type dental surface coating material using in the present invention, the polyfunctional (meth)acrylate monomer having 4 or more (meth)acryloyl groups in one molecular is preferably used as the (meth)acrylate monomer. The polyfunctional (meth)acrylate monomer having 4 or more (meth)acryloyl groups in one molecular is a monomer having a plurality of (meth)acryloyl groups acting as a cross-linking agent. Further, a monomer having as many polymerization reaction groups as possible is preferably selected in the monomer having the plurality of (meth)acryloyl groups. Then, the polyfunctional (meth)acrylate monomers obtained by modifying 4 or more hydroxyl groups with a (meth)acrylic ester in one molecular, such as, pentaerythritol(meth)acrylate, dipentaerythritol(meth)acrylate or the like are preferable. More particularly, at least the monomer selected from the followings is preferable, that is, dipentaerythritol tetra(meth)acrylate, dipenta erythritol tetra(meth)acrylate, dipentaerythritol penta(meth)acrylate, dipentaerythritol hexa(meth)acrylate, 1,3,5-tris(1,3-bis((meth)acryloyloxy)-2-propoxycarbonylaminohexane)-1,3,5-(1H,3H,5H)triazine-2,4,6-trione. In these monomers, when operability and safety are considered, the followings are the most preferable, that is, dipentaerythritol tetra(meth)acrylate, dipentaerythritol hexa(meth)acrylate, dipentaerythritol penta(meth)acrylate, and 1,3,5-tris(1,3-bis((meth)acryloyloxy)-2-propoxycarbonylaminohexane)-1,3,5-(1H,3H,5H)triazine-2,4,6-trione.

As the (meth)acrylate monomer used in the photopolymerization type dental surface coating material, 0.1-10.0% by weight of (meth)acrylate monomer having an adhesive functional group in the (meth)acrylate monomer can be used. In this case, direct adhesion to a dental cement, a denting, a dental alloy or the like is improved, where the adhesion of these materials is low with respect to the photopolymerization type dental surface coating material. As the (meth)acrylate monomer having the adhesive functional group, the alkoxysilane having an unsaturated double bond, or a (meth)acrylate monomer having an acidic group can be used. As the (meth)acrylate monomer having an acidic group, the following monomers are preferable, that is, a polymerizable monomer or oligomer having an acryloyl group, a methacryloyl group or the like with a carboxyl group, a phosphate group, an acid anhydride residual group, an acid amido group or the like.

As the (meth)acrylate monomer having a carboxyl group, for example, the followings can be used, that is, (meth)acrylic acid, 1,4-di(meth)acryloxyethyl pyromellitic acid, 6-(meth)acryloxyethylnaphthalene 1,2,6-tricarboxylic acid, N,O-di(meth)acryloxytylosin, O-(meth)acryloxytylosin, N-(meth)acryloxytylosin, N-(meth)acryloxyphenylalanine, N-(meth)acryloyl-p-aminobenzoic acid, N-(meth)acryloyl-o-aminobenzoic acid, N-(meth)acryloyl-5-aminosalicylic acid, N-(meth)acryloyl-4-aminosalicylic acid, 4-(meth)acryloxyethyltrimellitic acid, 4-(meth)acryloxybutyltrimellitic acid, 4-(meth)acryloxyhexyltrimellitic acid, 4-(meth)acryloxydecyltrimellitic acid, 4-(meth)acryloxybutyltrimellitic acid, 2-(meth)acryloyloxybenzoic acid, 3-(meth)acryloyloxy benzoic acid, 4-(meth)acryloyloxybenzoic acid, an addition product of 2-hydroxyethyl(meth)acrylate and maleic anhydride, P-vinylbenzoic acid, O-(meth)acryloxytylosinamide, N-phenylglycine-glycidyl(meth)acrylate, N—(P-methylphenyl)glycine-glycidyl(meth)acrylate, 11-(meth)acryloxy-1,1-undecanedicarboxylic acid, 4-[(2-hydroxy-3-(meth)acryloyloxypropyl)amino]phthalic acid, 5-[(2-hydroxy-3-(meth)acryloyloxypropyl)amino]isophthalic acid, 3-[N-methyl-N-(2-hydroxy-3-(meth)acryloyloxypropyl)amino]phthalic acid, 4-[N-methyl-N-(2-hydroxy-3-(meth)acryloyloxypropyl)amino]phthalic acid, maleic acid, or the like.

As the (meth)acrylate monomer containing a phosphate group, for example, a (meth)acrylate monomer containing phosphoric acid and a phosphonic acid group is preferable. More particularly, the followings can be used, that is, 2-(meth)acryloxyethyl phosphoric acid, 2-(meth)acryloxyethylphenyl phosphoric acid, 10-(meth)acryloyloxydecyldihydrogen phosphate, vinyl phosphonic acid, para-vinylbenzylphosphonic acid, or the like. In addition, a (meth)acrylate monomer containing a thiophosphate group can be also used.

As the (meth)acrylate monomer having an acid anhydride residual group, for example, the followings can be used, that is, 4-(meth)acryloxyethyl trimellitic acid anhydride, 6-(meth)acryloxyethylnaphthalene 1,2,6-tricarboxylic acid anhydride, 6-(meth)acryloxyethyl naphthalene 2,3,6-tricarboxylic acid anhydride, 4-(meth)acryloxyethylcarbonylpropanoyl 1,8-naphthalic acid anhydride, 4-(meth)acryloxyethylnaphthalene 1,8-tricarboxylic acid anhydride. The polymerizable compounds having these acid groups may be used by mixing 2 or more kinds.

As for the blending amount of the (meth)acrylate monomer having an adhesive functional group, it is preferably 0.1-10.0% by weight of the whole (meth)acrylate monomer, and more preferably 0.5-5.0% by weight. When it is less than 1% by weight, the adhesion of the photopolymerization type dental surface coating material may decrease. When it is more than 10.0% by weight, the curability of the surface of the photopolymerization type dental surface coating material may decrease.

In the photopolymerization type dental surface coating material, a photopolymerization type and commonly known polymerization catalyst is used. As the photopolymerization catalyst, a catalyst obtained by combining a sensitizer and a reducing agent is generally used. As the sensitizer, the followings can be used independently or by mixing. That is, camphorquinone, benzil, diacetyl, benzyldimethylketal, benzyldiethyl ketal, benzyl (2-methoxyethyl)ketal, 4,4′-dimethylbenzyl-dimethylketal, anthraquinone, 1-chloroanthraquinon, 2-chloroanthraquinon, 1,2-benzanthraquinone, 1-hydroxyanthraquinone, 1-methylanthraquinone, 2-ethylanthraquinone, 1-bromo anthraquinone, thioxanthone, 2-isopropylthioxanthone, 2-nitrothioxanthone, 2-methylthioxanthone, 2,4-dimethylthioxanthone, 2,4-diethylthioxanthone, 2,4-diisopropylthioxanthone, 2-chloro-7-trifluoromethyl thioxanthone, thioxanthone-10,10-dioxide, thioxanthone-10-oxide, benzoin methyl ether, benzoin ethyl ether, isopropyl ether, benzoin isobutyl ether, benzophenone, bis(4-dimethylamino phenyl)ketone, 4,4′-bisdiethylaminobenzophenone, acyl phosphine oxide such as 2,4,6-trimethylbenzoil diphenylphosphine oxide or the like, or a compound containing an azido group.

As the reducing agent, a tertiary amine is generally used. As the tertiary amine, the followings are preferable, that is, N,N-dimethyl-p-toluidine, N,N-dimethylaminoethylmethacrylate, triethanolamine, 4-dimethylamino methyl benzoate, 4-dimethylamino ethyl benzoate, 4-dimethylamino isoamyl benzoate. Further, as the other reducing agent, the followings can be used, that is, benzoyl peroxide, sodium sulfinate derivative, an organometallic compound or the like.

In the present invention, 0.01-10 parts by weight of photopolymerization catalyst is blended with respect to 100 parts by weight of the sum content of the (meth)acrylate monomer and the inorganic fine particles, which has 1-100 nm average particle diameter and the surface modified with alkoxysilane having an unsaturated double bond, of the photopolymerization type dental surface coating material. When the blending amount is less than 0.01 parts by weight, polymerization curability is inferior. When the blending amount is more than 10 parts by weight, storage stability of the photopolymerization type dental surface coating material decreases.

The photopolymerization type dental surface coating material according to the present invention is needed to have the viscosity of 5000 cP or less at 23° C. If the viscosity is more than 5000 cP, the operation for coating on the dental material becomes difficult, the coated film becomes thick, and the strength of the surface after curing decreases. The low viscosity is preferable, and the viscosity of 5-100 cP is more preferable.

Further, to the photopolymerization type dental surface coating material using in the present invention, the followings can be suitably blended, that is, a colorant, a polymerization inhibitor, an ultraviolet absorbing agent, an antibacterial agent, a fluorescence agent, a perfume or the like.

### EXAMPLES

A silica-alumina water mono-dispersion sol (Cataloid-SN made by CATALYSTS CHEMICALS IND. CO., LTD. having 12 nm average particle diameter and 20% by weight silica-alumina concentration) is used as a starting material. A methanol mono-dispersion sol with solid concentration of 20% by weight was made using this silica-alumina water dispersion sol by substituting the solvent from water to methanol. Then, a mono-dispersion sol, in which the surfaces of the silica-alumina particles are modified with 3-methacryloxypropyl trimethoxysilane, was made by mixing this methanol mono-dispersion sol and ethanol, and then adding 3-methacryloxypropyl trimethoxysilane to the mixed liquid. Next, the solvent of the obtained mono-dispersion sol was substituted to methylmethacrylate, and a methylmethacrylate mono-dispersion sol of silica-alumina, in which the surfaces were modified with 3-methacryloxypropyl trimethoxysilane, was obtained. This methylmethacrylate mono-dispersion sol of a surface modified silica-alumina has 12 nm average particle diameter of silica-alumina and 20% by weight concentration,, and this sol is said to as “the raw material 1” hereinafter.

A methylmethacrylate mono-dispersion sol of a surface-modified silica was obtained like the raw material 1 except a silica water dispersion sol having 12 nm average particle diameter and 50% by weight silica concentration was used as the starting material in the preparing process of the raw material 1. This methylmethacrylate mono-dispersion sol has 12 nm average particle diameter and 50% by weight solid concentration, and this sol is said to as “the raw material 2” hereinafter.

A methylmethacrylate mono-dispersion sol of a surface-modified silica-zirconia was obtained like the raw material 1 except a silica-zirconia water dispersion sol having 30 nm average particle diameter and 20% by weight silica-zirconia concentration was used as the starting material in the preparing process of the raw material 1. The methylmethacrylate mono-dispersion sol has 30 nm average particle diameter and 20% by weight silica-zirconia concentration, and this sol is said to as “the raw material 3” hereinafter.

The blending ratios of examples of the photopolymerization type dental surface coating material 1-5 and comparison example's of the photopolymerization type dental surface coating material 1-3 were shown in Table 1. 0.5 parts by weight of camphorquinone, 0.25 parts by weight of 4-dimethylamino methyl benzoate and 0.5 parts by weight of (2,4,6-trimethylbenzoil) diphenylphosphine oxide were added to the 100 parts by weight of (meth)acrylate monomers and above raw materials blended as described in Table 1. After mixing, the surface curability, the abrasion resistance and the viscosity of each photopolymerization type dental surface coating material were measured.

The curability measurement was carried out as follows, that is, the method comprising, evenly coating each photopolymerization type dental surface coating materials on a disc-like cured body having 15 mm diameter and 1.5 mm height, irradiating lights to the coated body for 20 seconds by a dental light irradiator (LABOLIGHT LV-II, made by GC Corporation) to cure the surface, strongly rubbing the surface of the cured body for 20 seconds by a hard paper (JK WIPER-150-S, made by CRECIA Co., Ltd.), and observing surface properties of the body by viewing. The disc-like cured body was made with a glass ionomer cement for filling and repairing (FUJI IILC, made by GC Corporation). The curability was decided as following basis. These results were shown in Table 1 collectively.

A: The surface of the cured body was not tacky and hardly had scratches.
B: The surface of the cured body was not tacky but has some scratches.
C: The surface of the cured body was tacky and had many scratches because it was an unpolymerized polymer.

### Evaluation of the Abrasion Resistance

A stainless steel frame having 5 mm overall height was used for making test pieces. The inside of the frame has a shape consisting of a base part having 6 mm diameter and 2 mm height, a test plane having 2.1 mm diameter and 1 mm height, and a truncated conical intermediate part having 2 mm height. This frame was put on a glass board so as to direct the test plane downward. Each photopolymerization type dental surface coating material of examples and comparison examples was charged into the frame by about half, and irradiated by lights for 60 seconds using a visible beam radiator (NEWLIGHT VL-II, made by GC Corporation). Then, the photopolymerization type dental surface coating material was charged to the base plane, and pressure-contacted with the glass board through a cellophane and irradiated by lights for 60 seconds using the visible beam radiator (NEWLIGHT VL-II, made by GC Corporation). After being irradiated more by lights from the test plane for 30 seconds using the visible beam radiator (NEWLIGHT VL-II, made by GC Corporation), the test pieces were removed from a mold and immersed in distilled water at 37° C. for 24 hours. The test pieces were mounted to an abrasion testing machine, and reciprocally moved left and right on an emery paper (#600.fwdarw.#1000), to make the base plane and the test plane in parallel each other. The test pieces were once removed and the base parts of the test pieces were coated with a silicone impression material. This test pieces were immersed in a 0.1N—NaOH aqueous solution at 37° C. for 6 days. After washing with the distilled water, the height of the test pieces were measured by a micrometer, and were mounted to the abrasion testing machine. A polishing material comprising a spherical powder (250 μm or less) of polymethyl methacrylate and glycerin (1/1 (w/V)) was poured on a polishing cloth stuck on the flat glass board. The load to the test piece was set to 8.84 kgf/cm². As one right and left reciprocating movement (25 mm sliding distance) was one cycle, the test piece was subjected to a compression sliding movement of 100,000 cycles at 130 cycles per minutes. After the test, the height of the test piece was measured. The difference before and after the test was the abrasion loss. These results were shown in Table 1 collectivity.

### Measuring of the Viscosity

The viscosities were measured at a room temperature (23° C.) using a B type rotational viscometer. These results were shown in Table 1 collectivity.

In examples of the photopolymerization type dental surface coating material 1-5, all results were preferable. In comparison examples of the photopolymerization type dental surface coating material 1-3, the abrasion resistance is low because of not mono-dispersing the inorganic fine particle having 1-100 nm average particle diameter and the surface modified with alkoxysilane having an unsaturated double bond.

TABLE 1

| | | | | | | | | Comparative | | |
|---|---|---|---|---|---|---|---|---|---|---|
| | | | | | | | | examples of | | |
| | | | Photopolymerization | | | | | photopolymerization | | |
| | | | type dental surface | | | | | type dental surface | | |
| | | | coating material | | | | | coating material | | |
| Units (g) | | | 1 | 2 | 3 | 4 | 5 | 1 | 2 | 3 |
| Raw materials | 1: MMA | Average | 5 | 30 | | | 30 | | | |
| | mono-dispersed | Particle | | | | | | | | |
| | gel of 20% by | Diameter: | | | | | | | | |
| | weight of | 12 nm | | | | | | | | |
| | silica and | | | | | | | | | |
| | alumina | | | | | | | | | |
| | 2: MMA | Average | | | 50 | | | | | |
| | mono-dispersed | Particle | | | | | | | | |
| | gel of 50% by | Diameter: 12 nm | | | | | | | | |
| | weight of | | | | | | | | | |
| | silica | | | | | | | | | |
| | 3: MMA | Average | | | | 30 | | | | |
| | mono-dispersed | Particle | | | | | | | | |
| | gel of 20% by | Diameter: | | | | | | | | |
| | weight of | 30 nm | | | | | | | | |
| | silica and | | | | | | | | | |
| | zirconia | | | | | | | | | |
| (Meth)acrylate | Volatile | MMA as a | 4 | 24 | 40 | 24 | 24 | | | |
| monomer | (meth)acrylate | solvent of a | | | | | | | | |
| | monomer | raw material | | | | | | | | |
| | | MMA | 55 | 30 | 10 | 30 | 30 | 60 | 25 | 55 |
| | | MA | | 1 | | | | | | |
| | | 3FE | 1 | | 1 | | | | | |
| | polyfunctional | DPE-6A | 39 | 39 | 23 | | | 39 | 70 | |
| | (meth) acrylate | U6HA | | | | 39 | | | | 40 |
| | monomer having | DPE-4A | | | | | 39 | | | |
| | 4 or more | | | | | | | | | |
| | (meth)acryloyl | | | | | | | | | |
| | groups in one | | | | | | | | | |
| | molecule | | | | | | | | | |
| | Other | 4-AETA* | | | 1 | | | 1 | | |
| | (meth)acrylate | 3APT* | | | | | 1 | | | |
| | monomers | | | | | | | | | |

| | | | | | | | | |
|---|---|---|---|---|---|---|---|---|
| Inorganic fine | Silica/alumina (average | 1 | | 25 | | | | 5 |
| particles | particle diameter of 12 nm) | | | | | | | |
| | Silica (average particle | | | | 7 | 6 | 5 | |
| | diameter of 12 nm) | | | | | | | |
| | Silica/zirconia (average | | 6 | | | | | |
| | particle diameter of 30 nm) | | | | | | | |

| | | | | | | | | |
|---|---|---|---|---|---|---|---|---|
| Total | 100 | 100 | 100 | 100 | 100 | 100 | 100 | 100 |
| Total of (Meth)acrylate monomers | 99 | 94 | 75 | 93 | 94 | 100 | 95 | 95 |
| Total of adhesive (meth)acrylate monomers | 0 | 0 | 1 | 0 | 1 | 1 | 0 | 0 |
| Ratio of adhesive (meth)acrylate monomers | 0.0 | 0.0 | 1.3 | 0.0 | 1.1 | 1.0 | 0.0 | 0.0 |
| (% by weight) | | | | | | | | |
| Surface curability | A | A | A | A | A | A | B | B |
| Abrasion resistance (μm) | 18 | 13 | 10 | 11 | 13 | 456 | 118 | 95 |
| Viscosity at 23° C. (cP) | 4 | 12 | 18 | 19 | 21 | 10 | 15 | 12 |

MMA: Methyl methacrylate
MA: Methyl acrylate
3FE: 2,2,2-trifluoroethyl methacrylate
DPE-6A: Dipentaerythritol hexaacrylate
U6HA: 1,3,5-tris[1,3-bis((meth)acryloyloxy)-2-propoxycarbonylaminohexane]-1,3,5-(1H,3H,5H)triazine-2,4,6-trione
DPE-4A: Dipentaerythritol tetra acrylate
4-AETA*: 4-acryloxyethyl trimellitate
3APT*: 3-acryloxypropyltrimethoxysilane
The symbol “*” indicates that a material has the adhesion.

A plaque on a smooth surface of an erupted tooth was removed, and the tooth surface was washed. A photopolymerization type dental surface coating material of Examples 1-3 were applied thinly to the smooth surface by using an application brush, and the photopolymerization type dental surface coating material was irradiated for 30 seconds by a dental visible ray iddadiator (the product name; NEW LIGHT VL-II, produced by GC Corporation) and was polymerized and hardened. When the photopolymerization type dental surface coating material was observed after half year, peeling of the photopolymerization type dental surface coating material was not confirmed, and a dental caries, a white spot or the like were not confirmed.

A photopolymerization type dental surface coating material of Examples 4-5 were thinly applied by using a application brush so as to cover an entire side surface of the sixth molar of an adult man, where white spots were confirmed on the cheek side surface of the sixth molar. Then, the photopolymerization type dental surface coating material was irradiated for 30 seconds by a dental visible ray irradiator (the product name; NEW LIGHT VL-II, produced by GC Corporation), and this irradiation was performed 4 times so as not to arise unevenness of the irradiation. When the photopolymerization type dental surface, coating material was observed after half year, peeling of the photopolymerization type dental surface coating material from the tooth surface was not confirmed. The white spots did not change from a state at a time of the tooth surface treatment, and a dental caries did not progress.

What is claimed is:

1. A method of tooth surface treatment comprising of firstly, applying a photopolymerization type dental surface coating material to smooth surface of an erupting or erupted tooth and/or smooth surface of a non cavitated caries lesion, and secondly, irradiating a visible light to polymerize the photopolymerization type dental surface coating material.

2. The method of tooth surface treatment as claimed in claim 1,
the photopolymerization type dental surface coating material having:
1-70% by weight of inorganic fine particles, having 1-100 nm average particle diameter, with their surfaces modified with alkoxysilane having an unsaturated double bond and is comprised of a (meth)acrylate monomer in the mono-dispersed state,
0.01-10 parts by weight of photopolymerization catalyst is contained with respect to 100 parts by weight of said monomer dispersed with said fine particles
viscosity level of 5000 cP, or less, at 23° C.

3. The method of tooth surface treatment as claimed in claim 1,
wherein 15-70% by weight of volatile (meth)acrylate monomer is contained as (meth)acrylate monomer.

4. The method of tooth surface treatment as claimed in claim 1 or 2,
wherein 15-70% by weight of polyfunctional (meth)acrylate monomer having 4 or more (meth)acryloyl groups in one molecule is contained as the (meth)acrylate monomer.

5. The method of tooth surface treatment as claimed in claim 4,
wherein the polyfunctional (meth)acrylate monomer having 4 or more (meth)acryloyl groups in one molecule is at least one monomer selected from a following group dipentaerythritol tetra(meth)acrylate, dipentaerythritol hexa(meth)acrylate, dipentaerythritol penta(meth)acrylate, and 1,3,5-tris[1,3-bis((meth)acryloyloxy)-2-propoxycarbonylaminohexane]1,3,5-(1H,3H,5H)triazine-2,4,6-trione.

6. The method of tooth surface treatment as claimed in claim 1,
wherein 0.1-10% by weight of (meth)acrylate monomer having an adhesive functional group is contained in (meth)acrylate monomer.
